(19) United States
(12) Patent Application Publication
(10) Pub. No.: US 2019/0354557 A1
(43) Pub. Date: Nov. 21, 2019

(54) System and Method For Providing Intelligent Customer Service

(71) Applicant: Tom Kornblit, Lafayette, CA (US)

(72) Inventor: Tom Kornblit, Lafayette, CA (US)

(21) Appl. No.: 15/628,224

(22) Filed: Jun. 20, 2017

(51) Int. Cl. G06F 16/9032; H04L 12/58; G06Q 30/02; G06K 9/62

(52) U.S. Cl. CPC G06F 16/90332; G06K 9/6278; G06Q 30/0281; H04L 51/02

(57) ABSTRACT

The present invention consists of an intelligent plugin to electronic customer service technology infrastructure. The plugin is installed as a software layer on an existing customer service platform, and provides an end-to-end intelligent customer service solution without need for human intervention. The system initially undergoes a learning phase by listening in on customer service interactions between a customer and a human agent. During that phase, the system learns the universe of potential topics of conversation that may occur between a customer and a customer service agent. The system also learns the universe of potential questions within those topics, and learns to provide answers. Once placed into full service, the system can continue to learn on the job by requesting help from a live agent. The number of instances in which human customer service agents are needed decreases sharply as the system's knowledge grows.

### FIELD OF THE INVENTION

The present invention relates to the field of artificial intelligence. More particularly, the present invention discloses a fully automated intelligent system and method for interactive online communication.

### BACKGROUND OF THE INVENTION

Many modern businesses depend on Internet capability, and operate partially or fully online. To that end, an increasing number of businesses have Internet-based customer support modules. Those modules include chat functions, whereby customers can receive real-time support online. Using chat support functionality, customers can type questions into a chat box on the business webpage, and receive real-time answers. The availability of chat support is convenient for customers as it obviates the need to wait in a telephone queue. Through the Internet chat support, customers can receive various types of assistance without significantly interrupting their workday or other tasks.

However, as more and more customers default to using chat support as opposed to telephone or other means of support, chat functionality becomes congested and consumers end up in an electronic queue, in lieu of a telephone queue. As a result, businesses may lose sales or may otherwise lose customers, and customers may become dissatisfied with the support functions provided by the business.

Importantly, as customer demand for chat assistance grows, companies incur additional overhead expenses by way of hiring and training personnel to respond to customer questions via chat. As a result, there is a need for improved chat that decreased customer wait time and reduces overhead expenses for businesses. As businesses transition more and more to electronic functionality, this need will continue to grow.

The present invention discloses a system and method for employing a so called closed-loop AI-powered chat module. The system and method disclosed in the present invention automatically learns on an ongoing basis on the job, and greatly reduces the chat volumes for human agents as it learns and expands its knowledge.

Certain existing systems provide online chat functionality. For example, some existing systems analyze preliminary input in order to direct the user to the appropriate agent. Other systems use intelligent functions to record user communications in order to improve future interactions. Some systems even offer automated responses. However, those systems rely partially or fully on a human agent to manage the AI plugin/software, and do not provide a complete, closed-loop learning environment. As a result, existing systems are not an ideal, or very practical solutions for modern businesses and would not significantly improve efficiency by eliminating the need for human agents, as those systems also need to add additional overhead work to manage the AI plugin software. The device of the present invention solves those and other problems as disclosed herein.

### SUMMARY OF THE INVENTION

The current invention addresses the foregoing issues and drawbacks. In one embodiment, the present invention consists of a novel artificial intelligence system, and method for using that system, to provide a complete end-to-end intelligent means for eliminating the necessity for human intervention in each interaction, and to answer user questions, facilitate purchases and/or otherwise provide information or complete commercial transactions.

The system of the present invention consists of an end-to-end intelligent customer service solution, which receives and analyzes a customer query, and provides an answer to the customer. The system learns on an ongoing basis by requesting assistance from live agents when it is not confident about an answer to the query, and then training itself with that new answer. As a result, human customer service agents may be removed from the loop when the customer poses a question to which the system has already learned an answer. There is absolutely no maintenance of the AI software. It merely acts as a plugin on top of the existing Customer service query-answer chat workflow.

The system includes a novel clustering algorithm, which analyzes conversation data, and clusters that data into separate topics of conversation. When a new conversation occurs, the algorithm is then able to identify the topic of the conversation. The novel clustering algorithm works in conjunction with a classifier, which utilizes the output of the clustering algorithm and identifies an answer to provide to the customer. The system further includes a chat bot, which receives the query from the customer, checks with the current knowledge of AI, if it has the answer it will answer automatically, otherwise it will request assistance from an agent.

In the present invention, the user navigates to a website using a browser which is enabled by the user's computer. The computer may consist of any known computing machine, such as a personal computer, laptop, tablet, or other mobile computer including a smart telephone. A server provides data from the website to the user's browser. In the exemplary embodiments described herein, the website is a commercial website, such as that of a bank, real estate agency, retailer, or other commercial website. However, the present invention could also be used in connection with other websites such as internal workplace portals, or other websites.

In a preferred embodiment, the present invention is installed as a software layer on an existing website with chat capabilities. When a user navigates to the website from their computer terminal, they are presented with a portion of the webpage that consists of a box or other pre-defined chat area. Text that the user enters on their keyboard or screen appears in that predefined chat area, is transmitted over a network, and received and processed by a chatbot. The chatbot will then check with the artificial intelligence (“AI”) brain. If the brain can identify the topic, it will immediately return the answer associated with that topic to the user. In the event that it does not know the answer, it will request assistance from a live agent, once the live agent assists the customer, it will learn from that interaction, so it can masterfully answer the question upon subsequent requests of that same topic.

### BRIEF DESCRIPTION OF THE DRAWINGS

FIG. 1 depicts a prior art chat functionality.

FIG. 2 depicts a chat window from the user's perspective.

FIG. 3 depicts the intelligent chat functionality of the present invention.

FIG. 4 depicts the architecture of the present invention.

### DETAILED DESCRIPTION OF THE PREFERRED EMBODIMENTS

The current invention is now described with reference to the figures. Components appearing in more than one figure bear the same reference numerals.

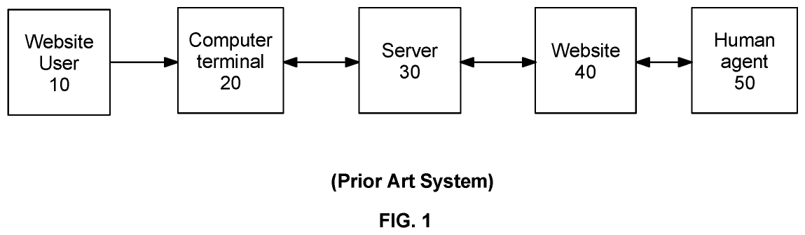

FIG. 1 depicts a system known in the art. As shown in FIG. 1, website user 10 connects to a chat-enabled website 40, via the user's computer terminal 20. The website 40 receives information from server 30. In the existing system, a human chat agent 50 receives text entered by user 10, and responds to that text.

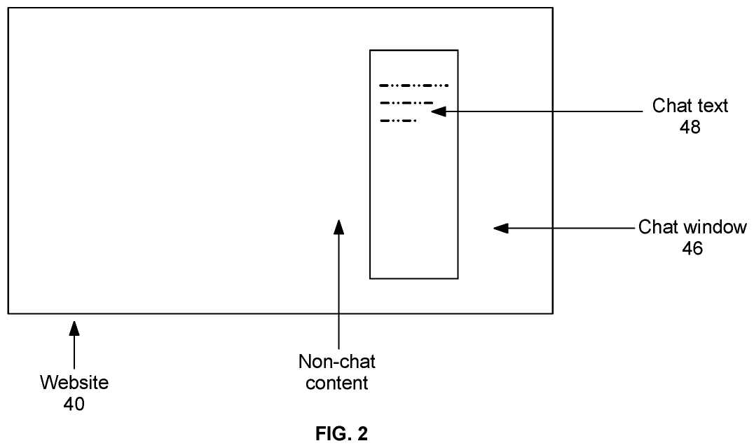

FIG. 2 depicts an exemplary chat window that can be employed in existing systems as well as in connection with the present invention. As shown in FIG. 2, a portion of the website 40 is designated as a chat window 46. Non-chat content 49 can also be displayed on the website. When the user 10 enters text on the keyboard of their terminal 20, or via other text entry means, the text appears as chat text 48. In existing systems, the human chat agent 50 enters responsive text from their computer terminal, and the user 10 sees that responsive text in chat window 48. As described herein, when the system of the present invention is installed, the human chat agent 50 is replaced with an intelligent chat bot, which provides answers in lieu of agent 50.

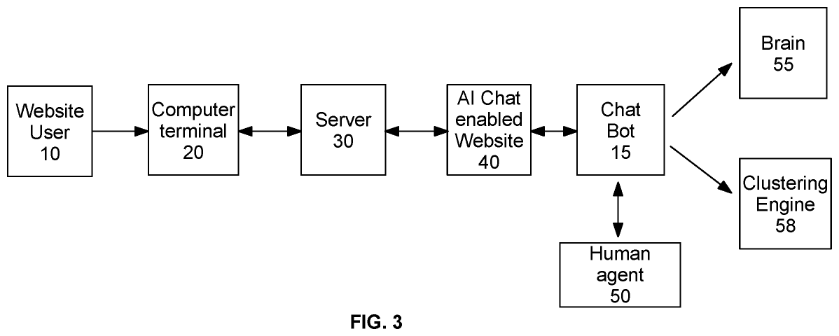

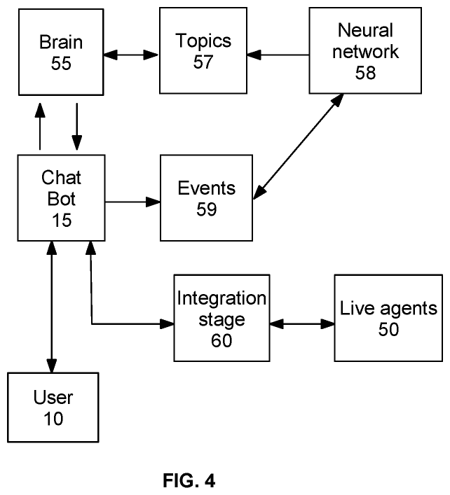

FIGS. 3 and 4 depict one embodiment of the present invention. As shown in those figures, the present invention is installed as a software layer on website 40. The present invention includes an AI brain 55, a neural network, or clustering engine 58, and a chat bot 15. User 10 enters a query into the website 40, which is displayed in chat window 46. Chat bot 15 receives user 10's query in the form of data transmitted over the network and forwards that information to other components of the system for processing. Once the system identifies the question and determines an answer, it provides that answer to chat bot 15. In turn, chat bot 15 enters the answer in text form, which is readable by user 10.

In one embodiment, the AI brain 55 may preferably consist of a Naive Bayes Classifier. The Naive Bayes Classifier is trained with the document-based topic data that we receive was the output of the clustering algorithm. In other embodiments, the system may be comprised of a different classifier.

In the preferred embodiment, clustering engine 58 is comprised of a clustering algorithm. The algorithm receives conversations that take place over chat on website 40, and categorizes different conversations into particular topics. The algorithm then outputs the topics as data objects. When the system is generating an answer in response to a question, brain 55 receives the topics from neural network 58. In order to generate an answer for user 10, brain 55 maps expressions and keywords to an answer and, returns that answer to chat bot 15.

The system of the present invention undergoes a learning phase when first installed on a website. During that learning phase, the system “listens in on” or observes chat interactions between a user 10 and a human agent 50. More particularly conversation data is passed from chat bot 15 to a document database. The conversations are generated by the chat interface as events 59, as shown in FIG. 4, as the user is interacting with the chat bot or the agent. Events 59 are stored in a database.

At scheduled intervals, the clustering engine 58 retrieves conversation data and processes it through a clustering algorithm. The clustering algorithm receives and analyzes the typed text as raw data and generates topics of conversation, which it stores as data objects. In one embodiment, the data objects may be stored in the same document database in which the raw conversation data is stored. In other embodiments, the topics may be stored in a dedicated database. In either case, the brain 55 and clustering engine 58 are both connected to the database and can store and retrieve the clustered data object.

The clustering algorithm assumes that the database contains prior queries from a consumer, or user 10, and answers to that query. The database is populated with those question and answer sets during the learning period.

The question and answer sets are pulled from the database and loaded into memory of clustering engine 58. The algorithm them compares each prior answer to every other prior answer. In that manner, it builds linear arrays of answer sets through tests of semantic similarities. In one embodiment, the algorithm employs the Spacy NLP library for its neural network similarity score algorithm.

Each time the algorithm encounters a new answer, it checks to see whether that answer is already included in an array. If it is already included, that answer is discarded. That self-checking heuristic increases efficiency and facilitates scaling.

The arrays of clustered answer sets are processed and the output correspond to topics of conversations that may possibly take place between a consumer and human agent. In FIG. 4, topics are shown as topics 57. In the case of a retail website, examples of topics could include questions on stock, such as whether a particular size or color is in stock, questions on price, such as whether a particular item is on sale, a return policy or shipping costs. Other topics are possible, and the topics will change depending on the particular nature of the website on which the present invention is installed.

During the final processing stage, the algorithm performs a localized NLP analysis on questions associated with the answer set nodes. Because the answer set nodes are clustered, the NLP analysis can be conducted in a localized manner, rather than on a global scale for each question.

Finally, the algorithm analyzes each question within each set, and identifies the question most semantically similar to each other question. Based on that information, the algorithm creates a topic data model including a topic name, questions within the topic, and answers to the topical questions.

Clustering engine 58 then passes the topic data model to brain 55 as data objects. Brain 55 maps keywords in topics to answers and in that way, it learns to identify the correct answer to provide to a client.

Once the system is placed into use, it receives and answers questions\without need for input from a live human agent. When placed into full use, the website user 10 enters text into the chat window 46. As shown in FIG. 4, that text is received by chat bot 15, and sent to clustering engine 58 and brain 55.

Clustering engine 58 identifies the topic about which user 10 is chatting, and provides that topic to brain 55. Brain 55 then maps the question to an answer, generates the answer and provides it to chat bot 15.

As shown in FIG. 4, in one embodiment of the present invention, a minimum number of live agents may be on standby if needed. If the system has not yet been educated on how to answer a particular topic or question, chat bot 15 will send a signal to a live agent, indicating that additional assistance is needed. Chat bot 15 will then allow the human agent to communicate through it with the user. In that embodiment, chat bot 15 will pass conversation data between the agent and the user to brain 55 and clustering engine 58. The components of the system will repeat the learning process described above with the new conversation data such that it will be able to automatically answer the question, the next time it is presented. In that manner, the system learns continuously, and the need for human agents decreases rapidly.

It should be understood that certain variations and modifications of this invention would suggest themselves to one of ordinary skill in the art. The scope of the present invention is not to be limited by the illustrations or the foregoing descriptions thereof. The above embodiments are exemplary, and other methods and structures may be employed to achieve the same end.

1. A system for providing interactive online communication between a human and an intelligent machine comprising:
a user computer;
an electronic network capable of receiving and transmitting data;
an intelligent data classifier; and
a clustering algorithm

2. The system of claim 1 wherein said intelligent data classifier is a Naive Bayes Classifier.

3. The system of claim 1 wherein said clustering algorithm categorizes electronic conversations into topics.

4. The system of claim 1 wherein said intelligent data classifier identifies a response to a user query.

5. A method for providing interactive online communication between a human and an intelligent machine comprising:
a user accessing a chat-enabled website;
said user entering a query through the chat-enabled website;
a chat bot receiving said query and providing it to an intelligent system for processing;
said intelligent system determining to what topic the query pertains;
said intelligent system determining what the answer to the query is; and
said chat bot providing the answer to the user.
